(19) United States
(12) Patent Application Publication
(10) Pub. No.: US 2005/0246204 A1
(43) Pub. Date: Nov. 3, 2005

(54) Method and system for transfer of data originating from a medical examination apparatus

(75) Inventor: Jurgen Simon, Forchheim (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/114,472

(22) Filed: Apr. 26, 2005

(30) Foreign Application Priority Data
Apr. 28, 2004 (DE) 10 2004 020 860.3

(51) Int. Cl. G06F 17/60

(52) U.S. Cl. 705/3; 705/2

(57) ABSTRACT

In a method, a data transmission device and a system for transfer of operating and/or error data originating from a medical examination apparatus from a user of the apparatus to a third-party organization, operating and/or error data of the medical examination apparatus necessary for determination of an operating and/or error state of the medical examination apparatus are initially selected from an accumulation of available data. The selected operating and/or error data are then filtered according to predetermined filter criteria by means of a filter device disposed in a secure area of the user, and the selected and filtered operating and/or error data are then forwarded to a reception device of the third-party organization.

### BACKGROUND OF THE INVENTION

1. Field of the Invention

The present invention concerns a method, a system and a data transfer device for transfer of operating and/or error data originating from a medical examination apparatus of a user to a third-party organization. The invention also concerns the use of a filter device to filter such operating and/or error data of a medical examination apparatus.

2. Description of the Prior Art

Coronary heart diseases, lung cancer and colon cancer are presently among the most frequent causes of death in industrial nations. Modern imaging modalities, such as computed tomography and magnetic resonance tomography, allow a relatively early detection of these diseases, whereby the therapy prospects are significantly improved. An increasing trend exists to use modern imaging systems not only for examination of patients with corresponding symptoms, but also for early detection of such diseases in people who still exhibit no symptoms whatsoever. Moreover, computed tomography and magnetic resonance tomography are also increasingly used for the precise diagnosis of a number of other diseases and for preparation of operative procedures. The number of such medical examination apparatuses therefore continuously increases. The expansion of such apparatuses into remote areas outside of population centers also increases.

To assure a high quality standard for the examinations, these complicated and expensive medical apparatuses must regularly undergo maintenance. Such maintenance and service tasks typically ensue through the manufacturer of the medical apparatuses or through specialized service organizations authorized by the manufacturer for these tasks. Furthermore, it is necessary for the apparatuses to be optimally quickly repaired or returned to service given a failure. It must be taken into account that the operational readiness of such an apparatus can be life saving, in particular when no second suitable apparatus is available in near proximity. Moreover, due to the generally high purchase costs, the downtime of such examination apparatuses should be kept optimally small. One problem hereby is in that, in most cases, no suitable service technician is on site. The time it takes the technician to arrive can significantly increase the time in which the apparatus cannot be used after a failure. Furthermore, the transit times for the technician are lost as effective work time since the technician cannot service or repair apparatuses during this time. The costs for the repair and regular maintenance of the apparatuses is consequently increased by the transit time of the technician. It is therefore desirable to reduce this transit time as much as possible.

For many types of failures, technical support or a specific remedy (workaround) could be very quickly given to the operator of a medical examination apparatus after a detailed error diagnosis using operating and error data of the appertaining apparatus without a technician having to travel to the apparatus. To accomplish this, however, it is necessary that the operating or error data be sent to the manufacturer of the apparatus, or to a suitable service organization.

In order to continuously further improve the technology of their medical apparatuses as well as the service for medical apparatuses, manufacturers of medical apparatuses are furthermore interested in acquiring as much information as possible, in particular operating and error data from the running operation of the medical apparatuses.

In principle, to achieve these goals, all operating and error data can be transmitted from the operator of the medical apparatus to the manufacturer. For operators of medical apparatuses, however, this has generally met with only a limited acceptance due to the high sensitivity to data protection laws in the medical sector.

### SUMMARY OF THE INVENTION

An object of the present invention is to provide a method and a system for transmission of operating and/or error data originating from a medical examination apparatus, in which the operator of the examination apparatus can be sure that no confidential information (in particular patient-related information which the operator is obligated to keep secret) reaches unauthorized people.

This object is achieved by a method according to the invention wherein necessary operating and/or error data of the medical examination apparatus data are initially selected from an accumulation of available data for determination of an operating and/or error state of the medical examination apparatus. The selected operating and/or error data are then initially filtered according to predetermined filter criteria by a filter device located in a secure (limited access) area of the user. Only then are the selected and filtered operating and/or error data forwarded to a reception device of the third-party organization.

The “source area” of the user is an area (physically or electronically defined) that is under the supervision of the user of the medical examination apparatus and that is largely safe from external accesses by unauthorized third parties, for example a physical region within the organization (for example a clinic or practice) of the user. Regions that are connected with the organization of the user, for example via secured transmission channels, also can be in the “source area”. In particular they can include other people or organizations that have the trust of the user, for example divisions in organizations that are otherwise responsible for the operation and the maintenance of the hardware and software in the user organization and are connected therewith these anyway over secure remote maintenance lines or the like.

A system for implementation of the method includes a selection device to select specific operating and/or error data necessary for determination of an operating and/or error state of the medical examination apparatus from an accumulation of available data of the medical examination apparatus. The operating and error data in principle can be all data that allows conclusions about the operating and/or error state of the apparatus. Such data include, among other things, operating data of the apparatus such as temperatures, voltages, currents, operating durations, etc., as well as specific measurement data that have been acquired in current or dated test measurements or “real” uses of the apparatus, i.e. for examinations of patients. The data can be both raw data and finished images. Given an apparatus failure, for example, virtually all data are sent that have been acquired in the measurement(s) in which the error occurred.

Moreover, this system has a filter device in the secure area of the user, in which filter device the operating and/or error data are filtered according to predetermined filter criteria, as well as a transmission device to forward the selected and filtered operating and/or error data to a reception device of the third-party organization.

By means of the inventive method and system, it is ensured that specific confidential data that must be kept secret, in particular patient-related data, do not proceed beyond the secure area of the operator of the medical examination apparatus. This leads to a larger number of users allowing a transfer of operating and/or error data of their medical examination apparatuses to third-party organizations such as the manufacturer of the apparatuses and/or suitable server operations, so that overall the downtimes as well as the costs can be reduced for maintenance of and restoring operation of the apparatuses.

In principle, the specific data sets can be completely removed from the selection operating and/or error data, for example when they are data sets that cannot reasonably be made anonymous without further steps.

Preferably, however, specific data sets of the selected operating and/or error data that contain, for example, personal data are modified only by the filter device. By this measure, the appertaining data sets can be made anonymous such that, for example, it is no longer recognizable from which patient the date originates. In many cases, making the data sets anonymous can be achieved in a simple manner, by removing specific data fields containing, for example, personal data, in the appertaining data sets.

In an embodiment of the inventive method, determination of data sets to be removed or to be modified and/or of data set fields to be removed from the operating and/or error data in the filtering ensues by a comparison with stored data types or data set types, based on specific characteristics. In general, it is likely data whatsoever with which the patient could be identifiable are contained in specific data sets. By contrast for other data sets it is clear (due to their type, for example recognizable by a specific file name) it is known at which position in the data set (for example in the “header” of an image file) personal data are stored. A significantly faster automatic filtering is possible using such a type comparison because the data contents do not have to be analyzed in detail.

An identifier can be associated with the transmitted data in the filtering. Personalization of anonymous data is possible later by the operator of the medical examination apparatus in the event that the original data or further data regarding a case, for example prepared image data of a specific examination, are sent back to the operator by the third-party organization. This means that, with the aid of the identifier, general operating and/or error data and/or response data sent back by the third-party organization can be supplemented again with associated data sets and/or data fields that were deposited in the storage unit upon filtering.

This embodiment assures that sensitive personal data remain in the secure area of the operator of the medical examination apparatus, and nevertheless the association of the transmitted operating and/or error data with the concrete case is not lost.

In a preferred embodiment, a removed data field is replaced by the corresponding identifier in a data set to be sent to the third-party organization. At the same time, the data sets and/or data fields removed in the filtering can be stored together with the identifier in the storage unit.

In a further embodiment of the inventive method the data to be filtered by the user are initially sent via a secured transmission channel to an external data transmission device that likewise is a part of the secure area of the user. The appertaining data is initially filtered by a filter device in this data transmission device before forwarding to the reception device of the third-party organization. In principle, a filter device in the secure area of the operator of the medical examination apparatus is unnecessary, with the secure transmission channel guaranteeing that the data of the user do not reach unauthorized parties.

This means that, in this embodiment, it is not necessary for the user to configure and maintain a filter device located within the user's organization, for example in the clinic or practice. This is advantageous because, depending on the type of the filtering, the configuration of the filter device can be relatively complicated and suitably trained personnel must be available for this. Furthermore, the configuration of the filter device should be optimally regularly updated in order to satisfy changing security requirements and/or file format changes. A one-time configuration of the filter device upon the installation is therefore, for the most part, insufficient. Particularly in smaller organizational units, for example in established practices, a specially-trained software technician who could be trusted with the operation, maintenance and configuration of the filter device would be under-worked, and therefore usually such personnel are not available at all. For the transmission of the operating or error data, such users of medical examination apparatuses can advantageously make use of an inventive data transmission device that is located in a group or entity classified by the user as trustworthy and, if necessary, can be appropriately monitored by the user. For example, such a group or entity can be an organization that regularly services the hardware and software within the user and therefore would have access to the data anyway. In many cases, suitable secure transmission channels already exist between such an organization and the user in order to also service other components within the user by means of remote maintenance methods.

Moreover, it is also possible to operate “trust centers” (secure areas) specifically for the data transfer of medical data, which trust centers provide inventive data transmission devices. These can be specialized to filter the most varied operating and/or error data from medical examination apparatuses as well as and to correspondingly configure the filters and adapt the configurations given changes of the data norms. Such trust centers could offer this service for various users.

It is important that the data can be transferred to this trust center with good security and that the trust center is monitored by corresponding monitoring devices and/or regular checks in order to maintain the confidence of the user in the trust center.

An inventive external data transmission device for transfer of data originating from a medical examination device of a user to a third-party organization must include a reception device which is connected with a transmission device of the user via a secured transmission channel and a transmission device that forwards the filtered operating and/or error data to a third-party organization. Moreover, a suitable filter device is provided to filter the operating and/or error data of he medical examination apparatus received from the user according to predetermined filter criteria.

This filter device is preferably designed as described in detail above and is arranged within the organization of the user or at the alternative locations described above.

Such an external data transmission device preferably additionally includes an accounting device in order to determine a cost value for the filtering based on the quantity of the filtered data or the time necessary for filtering the data. A simple charging of the operator of the medical examination apparatus and/or the third-party organization that would like to receive the corresponding operating and/or error data is possible in this manner.

It is also possible to equip an internal filter device (i.e. one arranged at the user) with an accounting device, for example when this filter device is provided and maintained by a trustworthy organization within the user, so the sent data likewise can be billed according to use time and/or quantity.

In a further embodiment the operating and/or error data are initially only pre-filtered within a first filter device located at the user. A portion of this data is then forwarded directly to the reception device of the third-party organization and another portion is sent to an external data transmission device for post-filtering with a second filter device.

For example, the pre-filtering can make use of the aforementioned data types to establish with surety that the pre-filtered data sets contain no personal data. These could then be sent directly. In contrast, data sets in which it is not unambiguously clear whether they contain data to be protected are supplied for post-filtering.

This embodiment avoids technically complicated complete filtering of the operating and/or error data form having to be undertaken at the user. Moreover, unnecessary data quantities are not sent to a trustworthy service organization for proceeding with the filtering.

An automatic selection of the operating and/or error data from the available data preferably ensues based on error typing. Thus, for example, the errors that have occurred can be associated with a specific error type based on data input by the user about possible errors or by evaluation of specific operating data. For this error type it can then already be established, from the accumulation of the available data, which types of operating and/or error data are actually necessary in order to more precisely establish where the occurred error lies.

Thus, for example, for some error types it may be necessary not only to send data from the current examination in which the error occurred, but also to send data from an earlier span of time. Moreover, for some error types it may be necessary to send image data, in contrast to which with other error types it can suffice to transmit operating data such as specific voltage values, temperatures, etc. With such an error type, the time for an automatic selection of the operating and/or error data can be greatly reduced.

In principle the user can directly choose operating and/or error data and select such data for further processing, in particular for filtering and for sending to third-party organizations.

In a preferred embodiment of the inventive method, before a sending of data to the third-party organization after the filtering, an explicit authorization by the user that the data may be sent in the filtered form must occur.

### DESCRIPTION OF THE DRAWINGS

FIG. 1 is a block diagram of a first embodiment of the inventive system for transfer of operating and/or error data of a medical examination apparatus.

FIG. 2 is a block diagram of a second embodiment of the inventive system for transfer of operating and/or error data of a medical examination apparatus.

FIG. 3 is a block diagram of a third embodiment of the inventive system for transfer of operating and/or error data of a medical examination apparatus.

### DESCRIPTION OF THE PREFERRED EMBODIMENTS

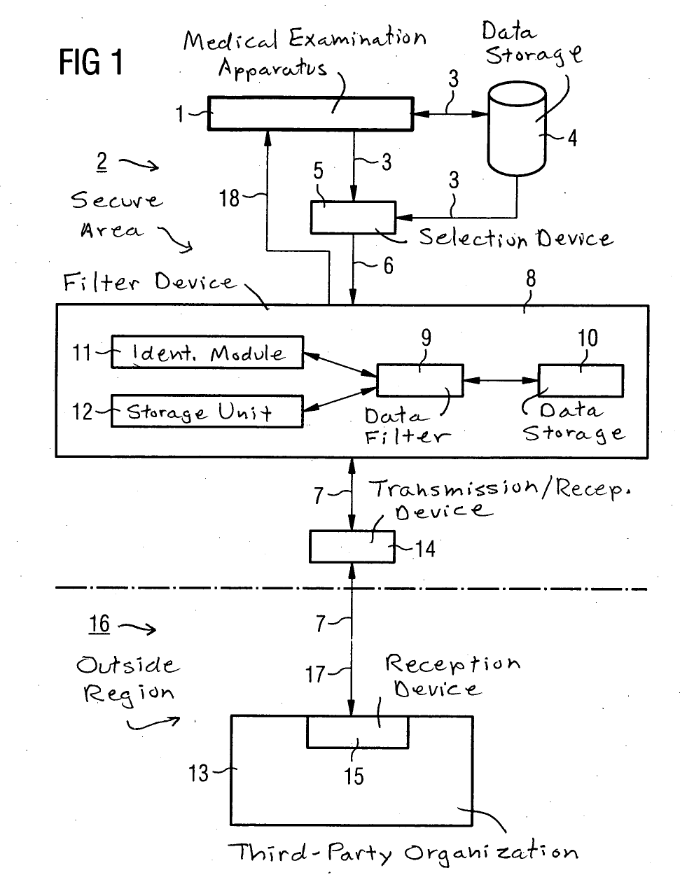

FIG. 1 shows a medical examination apparatus 1, for example a magnetic resonance tomography apparatus or a computed tomography apparatus, as a simple block in the diagram. Data 3 accumulating in the operation of the medical examination apparatus 1 are stored in a data storage 4 for archiving.

In the event of a failure or at specific points in time, for example at specific maintenance intervals, the current data generated by the medical examination apparatus 1 and/or the data 3 stored in the data storage 4 are checked or searched by a selection device 5. Specific operating and/or error data 6 that are useful for analysis of specific operating and/or error states of the medical examination apparatus 1 (and consequently also for its continuing technical development) are selected by the selection device 5 from the accumulated data 3. The operating and/or error data 6 selected by the selection device 5 still contain in part personal data and/or other data that must be kept secret by the operator of the medical examination apparatus 1.

The selection device 5 preferably automatically implements the selection of the operating and/or error data 6 based on error typing. The error typing can ensue, for example, based on a user input and/or on the basis of a self-diagnosis by the medical examination apparatus 1. For this, the selection device 5 includes an error-typing device (not shown in detail in the drawing). For example, the error-typing device contains pre-programmed error codes that correspond to specific failure scenarios of the medical examination apparatus 1. Furthermore, the error typing device is able to associate new error codes with error states of the medical examination apparatus 1 that are not predefined and preprogrammed, by means of which new error codes the selection device 5 then can select specific operating and/or error data 6 from the data 3.

The operating and/or error data 6 selected for transfer by the selection device 5 are subsequently fed to a filter device 8. For protection from manipulations by unauthorized third parties, this filter device 8 is located with a secure area 2 of the user, i.e. preferably within the clinic or practice in which the medical examination apparatus 1, the data storage 4 and the selection device 5 are also arranged.

In addition to the actual data filter 9, the filter device 8 has a data type storage 10, an identification module 11 as well as a storage unit 12. The identification module 11, the data storage 10 and the storage unit 12 do not thereby absolutely have to be arranged within the filter device 8, but the shown arrangement within the filter device 8 is preferable because the centrally-arranged devices can be more easily protected from unauthorized third parties.

All operating and/or error data 6 are filtered by the data filter 9 with regard to confidential data. For this, the data filter 9 in the filter device 8 must be configured with suitable filter rules such that, if applicable, specific data sets are removed from the operating and/or error data 6 or are modified as much as possible, for example made anonymous by removal of specific data fields. A data field is a specific data part within a data set. In the simplest case, such a data field contains, for example, a character string such as, for example, the name of the patient.

To simplify and accelerate the filtering of the operating and/or error data 6 within the data filter 9, the filter device 8 includes the data type storage 10. The data type storage 10 contains a combination of data types occurring within the operating and/or error data 6. For this combination of data types it is known without more precise content checking that they must be removed or modified (due to their personal contents) by means of the data filter 9 and, if applicable, in which manner the modification is necessary. If, for example, the data filter 9 recognizes a data set that corresponds to one of the data types stored in the data type storage and to be filtered out, this is filtered out by the data filter 9.

The data 7 checked and, if applicable, modified in the filter device 8 are then supplied to a transmission device 14, from which the data 7 are transmitted via a transmission channel 17 to a reception device 15 of a third-party organization 13. An arbitrary transmission channel 17, for example a telephone line, a radio connection or the Internet can be used for transfer. The transfer lends itself to use with general standards employed in the medical field such as, for example, the DICOM standard (Digital Imaging and Communication in Medicine).

The third-party organization 13, for example, can be the manufacturer of the medical examination apparatus 1, a service organization authorized by the manufacturer or the like which is located outside of the secure area 2 of the user, i.e. within a possibly non-secure outside region 16.

The filtered operating and/or error data 7 undergo a precise technical evaluation and analysis within the third-party organization 13. This technical evaluation can serve to enable the user of the medical examination apparatus 1 to be given a concrete assistance to remedy the problem given a failure, without requiring the presence of service personnel at the user.

In the filtering, data sets or data fields removed from the operating and/or error data 6 are provided with an unambiguous identifier by the identification module 11 and are subsequently stored together with the identification in the storage unit 12. The transmitted data 7 are likewise provided with this anonymous identifier. This means that, if the data filter 9 recognizes, for example, a data set that contains a critical data field, this data field is replaced with the identifier in the data set and the data set, made anonymous in this manner, is forwarded. The data field removed from the data set is likewise stored in the storage 12 together with the identifier.

With the unambiguous identifier, the filtered-out data sets or data fields stored in the storage unit 12 (that arise from an actual examination or other specific apparatus usage) can be linked them as needed with operating and/or error data 7 sent back by the third-party organization. The operating and/or error data 7, for example, can be supplemented with response data of the manufacturer of the medical examination apparatus 1 for remedy of a failure. Thus, for example, modified data sets from which specific data fields have been removed are completed again, i.e. personalized again.

The response data, for example, can be error data, error diagnosis data, reset data, inquiries for error localization or technical instructions that are suitable to give the operator an effective assistance in the remedy of failures or errors in the medical examination apparatus 1. The operating and/or error data transmitted back can also be sent back modified. For example, optimal magnetic resonance images can be reconstructed at the manufacturer from sent raw image data of a magnetic resonance apparatus and sent back to the user.

A transmission device is required at the third-party organization and a reception device is required at the user of the medical examination apparatus 2 for return of data from the third-party organization 13. In the shown example, the transmission device 14 of the user and the reception devices 15 at the third-party organization 13 are therefore combined transmission/reception devices 14, 15, and the return transmission ensues over the same transfer channel 17 as the forward transfer.

The operating and/or error data or response data sent back can be forwarded by the transmission/reception device 14 to the filter device 8 in which the linking with the stored, filtered-out data portions ensues. From there, a transmission of the data back to the medical examination apparatus 1 can ensue via a transmission channel 18.

Furthermore, the evaluation of the filtered operating and/or error data 7 within the third-party organization 13 can serve to technically further-develop the medical examination apparatus 1. For this purpose, a return transmission of the technically analyzed operating and/or error data 7 to the user is not absolutely necessary.

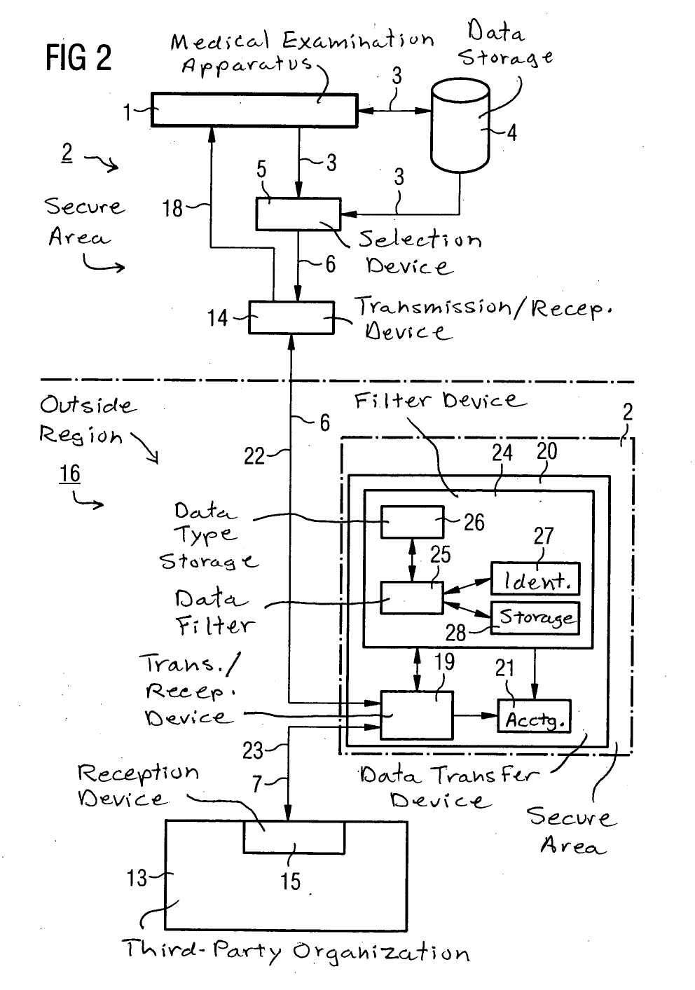

The system shown in FIG. 2 likewise has a medical examination apparatus 1 with a data storage 4, a selection device 5 as well as a transmission/reception device 14 in the region of influence (for example in the clinic or practice) of the user. The function of these components has already been discussed in connection with FIG. 1.

In contrast to the system according to FIG. 1, in FIG. 2 no data filter device is located in the immediate vicinity of the user. Instead of this, the operating and/or error data 6 selected from the data 3 by the selection device 5 are forwarded directly to the transmission/reception device 14.

The operating and/or error data 6 are then sent via a secure transfer channel 22 from the transmission/reception device 14 to an external data transfer device 20 that is located in the outside region, i.e. outside of the clinic or practice. The data transfer over the transfer channel 22 from the transmission/reception device 14 to the data transfer device 20 ensues with, for example, a strong encryption algorithm to secure the data.

In addition to a transmission/reception device 19 which receives the operating and/or error data 6 arriving from the transmission/reception device of the user via the transmission channel 22, located in this external data transfer device 20 are a filter device 24 which, among other things, comprises a data filter 25, a data type storage 26, an identification module 27 as well as a storage unit 28. The function of the filter device 24 and its components 25, 26, 27, 28 corresponds to the function of the filter device 8 as already been explained in connection with FIG. 1.

The operating and/or error data 7 checked and, if applicable, modified in the filter device 24 are then sent to the transmission/reception device 15 of the third-party organization 13 over a transmission channel 23 by the transmission/reception device 19.

This data transmission device 20 corresponds to the current security standard for information technology and is therefore nearly completely secure from external unauthorized accesses by third parties. Since no personal data or data otherwise to be kept secret can come out of the data transmission device 20 and this data transmission device is, as a “trust center”, charged by the user with the filtering and transmission of the sensitive operating and/or error data 6, is a part of the secure area 2 of the user of the medical examination apparatus 1.

The advantage of this arrangement is that the operator of the medical examination apparatus 1 does not have to more deal in detail with the configuration and the operation of a data filter 9. However, since all filter tasks are implemented in the secured, trustworthy data transmission device 20, misuse of confidential data contained in the operating and/or error data 6 is nevertheless nearly impossible.

A precise analysis and evaluation of the received operating and/or error data 7 ensues in the third-party organization 13 in the manner as explained in connection with the exemplary embodiment according to FIG. 1. If necessary, it is possible to transfer the received operating and/or error data 7 or response data back to the user.

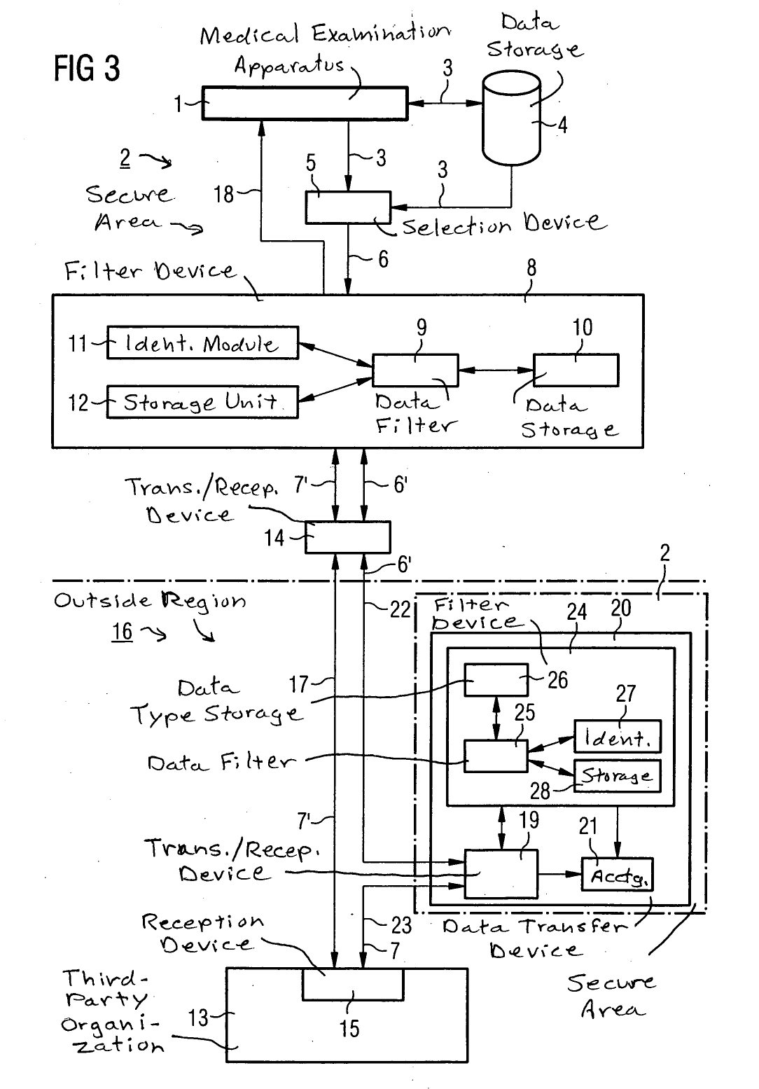

In the embodiment of FIG. 3 the appertaining data are transferred back via the data transmission device 20. A linking of the operating and/or error data or the response data with the data sets or data fields filtered out and stored in the storage unit 28 can ensue as far as possible within the data transmission device 20. Such a linking can ensue in the same manner as explained in connection with the exemplary embodiment according to FIG. 1.

The operating and/or error data as well as possible response data sent back and, if applicable, prepared then arrive back from the data transmission device 20 (via the secure transmission channel 22) at the transmission/reception device 14 at the user of the medical examination apparatus and from there, if applicable, arrive at the medical examination apparatus 1 over the transmission channel 18.

Moreover, the data transmission unit 20 has a costs accounting unit 21 with which the costs incurred for the transmission and filter services can be determined. In this context, a charge can be determined by the connection times to the transmission/reception devices 14, 15 and/or the data volume transferred over the transmission channels 22, 23 being monitored and, for example, a calculated charge being determined from this.

The system shown in FIG. 3 is a type of combination of the systems shown in FIGS. 1 and 2.

Here, in addition to the medical examination apparatus 1 with the data storage 4, the selection device 5 and the transmission/reception device 14, a filter device 8 is also located in the region of influence of the user of the medical examination apparatus 1. This filter device 8 in turn has a data filter 9, a data type storage 10, an identification module 11 as well as a storage unit 12. The functionality of all of these components is—to the extent that it is not explained different in the following—as in the exemplary embodiment according to FIG. 1.

In contrast to the filter device 8 described in connection with FIG. 1, in this third exemplary embodiment the data filter 9 effects only a “rough filtering” of the operating and/or error data 6.

In the “rough filtering”, it is checked whether specific data sets of the operating and/or error data 7′ can be directly transmitted over a transmission channel 17 from the transmission/reception device 14 of the user to the transmission/reception device 15 of the third-party organization 13 since these, with surety, contain no confidential data.

All other operating and/or error data 6′ are sent over a secure transfer channel 22 to an external data transmission device 20 (“trust center”) and there are run through a “fine filter stage”. This data transmission device 20 corresponds to the data transmission device 20 as already been explained in connection with FIG. 2.

The operating and/or error data 7 “finely filtered” within the data transmission device 20 are again transferred to the transmission/reception device 15 over the transmission channel 23 by the transmission/reception device 19.

As already explained in connection with the first exemplary embodiment of FIG. 1, in the event that it is necessary the third-party organization 13 can send specific—also modified—operating and/or error data as well as response data back to the filter devices 8, 24. Insofar as possible, linking with data stored there upon filtering then ensues in the filter devices 8, 24. A return sending of this data can ensues from the data transmission device 20 to the transmission/reception device 14 located in the medical examination apparatus 1 via the transmission channel 22.

This third variation has the advantage that high requirements are not placed on the configuration of the data filter 9 in this exemplary embodiment, compared to the first exemplary embodiment of the invention according to FIG. 1. The operator of the medical examination apparatus 1 still can assume personal responsibility for and monitor the configuration of the data filter 9, but without specially trained personnel. In particular the entire filter device does not have to be designed so elaborately as with a complete filtering of all data, i.e. here a very simple filter device would be sufficient.

Moreover, unnecessarily-large data quantities are not sent to the transmission device 20 for filtering and billed for there, which leads to this third variant possibly being more cost-effective in operation than the second variant.

The method workflows and system architectures specified in detail in the preceding are exemplary embodiments that can be modified by those skilled without departing from the scope of the invention. Thus, for example, instead of combined transmission/reception devices, separate transmission devices and receptions devices can also be used. Differently designed filter devices can be used, for example with multi-stage filters. Furthermore, for example, instead of a storage unit arranged within the filter device, a storage region within the storage used by the medical examination apparatus could also be used in order to store filtered data portions with association of an identifier.

The invention can be used with particular advantage for transmission of operating and/or error data from elaborate and costly medical examination apparatuses such as x-ray apparatuses, computer tomographs or magnetic resonance tomographs. In principle, however, data can be transmitted that originate from any other medical examination apparatuses.

1. A method for transferring data originating from a medical examination apparatus from a user of the medical examination apparatus to an organization outside of the user, comprising the steps of:
from data accumulating during operation of a medical examination apparatus, selecting operating and/or error data, as selected data, necessary for determining at least one of an operating state or an error state of the medical examination apparatus, said selected data possibly including confidential data;
filtering said selected data in a filter device disposed in a secure area of the user according to predetermined filter criteria to produce only non-confidential filtered data; and
forwarding said filtered data to a reception device of an organization outside of said user.

2. A method as claimed in claim 1 wherein said selected data possibly contain patient-related data as said confidential data, and wherein the step of filtering said selected data comprises filtering said selected data according to predetermined filter criteria to remove said patient-related data from said selected data.

3. A method as claimed in claim 1 wherein the step of filtering said selected data comprises removing specific data sets from said selected data according to said predetermined filter criteria.

4. A method as claimed in claim 3 comprising employing, as said predetermined filter criteria, a comparison of said selected data with stored types selected from the group consisting of stored data types and stored data set types.

5. A method as claimed in claim 3 wherein the step of filtering said selected data comprises electronically associating a unique identifier with each specific data set removed from said selected data and storing each removed specific data set together with the unique identifier therefor, and wherein the step of forwarding the filtered data to said organization outside of the user comprises forwarding the filtered data with said unique identifier to said organization outside of the user, and wherein said method comprises the additional steps of receiving, at the user, a response from the organization outside of the user to the filtered data forwarded to the organization outside of the user and, at the user, linking at least one of the stored, removed specific data sets to the response using said unique identifier.

6. A method as claimed in claim 1 wherein the step of filtering said selected data comprises modifying specific data sets in said selected data in said filter device.

7. A method as claimed in claim 6 wherein the step of modifying specific data sets comprises removing specific data fields from respective specific data sets.

8. A method as claimed in claim 7 comprising removing said selected data fields dependent on a comparison of data fields in said specific data sets with stored data selected from the group consisting of stored data types and stored data field types.

9. A method as claimed in claim 8 wherein the step of filtering said selected data comprises electronically associating a unique identifier with each specific data field removed from said selected data and storing each removed specific data field at the user together with the unique identifier therefor, and wherein the step of forwarding the filtered data to said organization outside of the user comprises forwarding the filtered data with said unique identifier to said organization outside of the user, and wherein said method comprises the additional steps of receiving, at the user, a response from the organization outside of the user to the filtered data forwarded to the organization outside of the user and, at the user, linking at least one of the stored, removed specific data field to the response using said unique identifier.

10. A method as claimed in claim 1 comprising locating said filter device in a secure area remote from said user, and wherein the step of forwarding the filtered data to said organization outside of the user comprises transmitting the selected data from the user to the filter device at said secure area via a secure transmission channel, and transmitting the filtered data from the filter device at said secure location via a further transmission channel to said organization outside of the user.

11. A method as claimed in claim 10 comprising pre-filtering said selected data at the user to obtain a first portion of pre-filtered data and a second portion of pre-filtered data, and directly transmitting said first portion of pre-filtered data to said organization outside of the user and transmitting said second portion of said pre-filtered data to said filter device at said secure area via said secure transmission channel.

12. A method as claimed in claim 1 wherein the step of selecting said operating and/or error data from data accumulated during operation of the medical examination apparatus comprises automatically selecting said operating and/or error data based on error typing.

13. A system for transferring data originating from a medical examination apparatus from a user of the medical examination apparatus to an organization outside of the user, comprising the steps of:
a selection unit supplied with data accumulating during operation of a medical examination apparatus, for selecting, from among said data, operating and/or error data, as selected data, necessary for determining at least one of an operating state or an error state of the medical examination apparatus, said selected data possibly including confidential data;
a filtering device disposed in a secure area of the user. said filter device being in connection with said selection unit and being supplied with said selected data therefrom, for filtering said selected data according to predetermined filter criteria to produce only non-confidential filtered data; and
a transmission device in communication with said filter device for forwarding said filtered data to a reception device of an organization outside of said user.

14. A system as claimed in claim 13 wherein said selected data possibly contain patient-related data as said confidential data, and wherein said filter device filters said selected data according to predetermined filter criteria to remove said patient-related data from said selected data.

15. A system as claimed in claim 13 wherein said filter device removes specific data sets from said selected data according to said predetermined filter criteria.

16. A system as claimed in claim 15 wherein said filter device, as said predetermined filter criteria, compares said selected data with stored types selected from the group consisting of stored data types and stored data set types.

17. A system as claimed in claim 15 wherein said filter device includes an identification module that electronically associates a unique identifier with each specific data set removed from said selected data and a storage in which each removed specific data set is stored together with the unique identifier therefor, and wherein said transmission unit forwards the filtered data to said organization outside of the user with said unique identifier, and comprising a reception device at the user, for receiving a response from the organization outside of the user to the filtered data forwarded to the organization outside of the user and for linking at least one of the stored, removed specific data sets to the response using said unique identifier.

18. A system as claimed in claim 13 wherein said filter device modifies specific data sets in said selected data.

19. A system as claimed in claim 18 wherein said filtering device modifies specific data sets by removing specific data fields from respective specific data sets.

20. A system as claimed in claim 19 wherein said filter device removes said selected data fields by comparing data fields in said specific data sets with stored data selected from the group consisting of stored data types and stored data field types.

21. A system as claimed in claim 20 wherein said filtering device includes an identifier module that electronically associates a unique identifier with each specific data field removed from said selected data and a storage in which each removed specific data field is stored together with the unique identifier therefor, and wherein said transmission device forwards the filtered data to said organization outside of the user with said unique identifier, and comparing a reception device, at the user, for receiving a response from the organization outside of the user to the filtered data forwarded to the organization outside of the user and for linking at least one of the stored, removed specific data field to the response using said unique identifier.

22. A system as claimed in claim 13 comprising locating said filter device in a secure area remote from said user, and wherein the step of forwarding the filtered data to said organization outside of the user comprises transmitting the selected data from the user to the filter device at said secure area via a secure transmission channel, and transmitting the filtered data from the filter device at said secure location via a further transmission channel to said organization outside of the user.

23. A system as claimed in claim 22 comprising a pre-filter for pre-filtering said selected data at the user to obtain a first portion of pre-filtered data and a second portion of pre-filtered data, and wherein said further transmission device directly transmits said first portion of pre-filtered data to said organization outside of the user and transmits said second portion of said pre-filtered data to said filter device at said secure area via said secure transmission channel.

24. A system as claimed in claim 13 wherein said selection unit automatically selects said operating and/or error data from said data accumulated during operation of the medical examination apparatus based on error typing.

25. A data transmission device for transferring data, originating from a medical examination apparatus of a user, from the user to an organization outside of the user, said data possibly containing confidential data, comprising:
a reception device adapted for receiving said data from the user via a secure transmission channel;
a filter device for filtering the data received by said reception device according to predetermined filter criteria to produce filtered data containing only non-confidential data; and
a transmission device adapted to forward the filtered data to a further reception device at the organization outside of the user.

26. A data transmission device as claimed in claim 25 comprising an accounting device connected to the filter device for automatically determining a charge to the user for filtering said data.
